(19) United States
(12) Patent Application Publication
(10) Pub. No.: US 2025/0330516 A1
(43) Pub. Date: Oct. 23, 2025

(54) LEADER ELECTION FOR ACTIVE-PASSIVE CONFIGURED CONTAINERIZED APPLICATION CLUSTERS

(71) Applicant: Dell Products L.P., Round Rock, TX (US)

(72) Inventors: Dan Aharoni, Brookline, MA (US); Evgeny Berger, Rehovot (IL)

(21) Appl. No.: 18/638,067

(22) Filed: Apr. 17, 2024

(51) Int. Cl. H04L 67/104

(52) U.S. Cl. CPC H04L 67/1051

(57) ABSTRACT

A method for designating an active pod replica amongst a plurality of pod replicas operating in an active-passive configuration within a containerized application cluster. The method includes: implementing, by a master node of the containerized application cluster, an elected leader lease; making an attempt, by a leader election container executing in a pod replica of the plurality of pod replicas, to acquire the elected leader lease; making a determination, based on the attempt and by the leader election container, that the elected leader lease has been successfully acquired; and designating, based on the determination and by the leader election container, the pod replica as the active pod replica.

### BACKGROUND

In keeping a high availability environment encompassing a single pod instance of containerized applications, pod rescheduling (or redeployment) times, following single node failure, can sometimes take minutes rather than seconds. This is unacceptable as said pod rescheduling/redeployment times are too prolonged to maintain high availability.

### SUMMARY

In general, in one aspect, embodiments described herein relate to a method for designating an active pod replica amongst a plurality of pod replicas operating in an active-passive configuration within a containerized application cluster. The method includes: implementing, by a master node of the containerized application cluster, an elected leader lease; making an attempt, by a leader election container executing in a pod replica of the plurality of pod replicas, to acquire the elected leader lease; making a determination, based on the attempt and by the leader election container, that the elected leader lease has been successfully acquired; and designating, based on the determination and by the leader election container, the pod replica as the active pod replica.

In general, in one aspect, embodiments described herein relate to a non-transitory computer readable medium (CRM). The non-transitory CRM includes computer readable program code, which when executed by computer processors, enables the computer processors to perform a method for designating an active pod replica amongst a plurality of pod replicas operating in an active-passive configuration within a containerized application cluster. The method includes: implementing, by a master node of the containerized application cluster, an elected leader lease; making an attempt, by a leader election container executing in a pod replica of the plurality of pod replicas, to acquire the elected leader lease; making a determination, based on the attempt and by the leader election container, that the elected leader lease has been successfully acquired; and designating, based on the determination and by the leader election container, the pod replica as the active pod replica.

In general, in one aspect, embodiments described herein relate to a containerized application cluster. The containerized application cluster includes a plurality of worker nodes. The plurality of worker nodes include a worker node. The worker node includes: a computer processor; a pod replica executing on the computer processor; and a leader election container executing on the computer processor and within the pod replica, and configured to perform a method for designating an active pod replica within the containerized application cluster. The method includes: making an attempt to acquire an elected leader lease; making a determination, based on the attempt, that the elected leader lease has been successfully acquired; and designating, based on the determination, the pod replica as the active pod replica.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1A shows a system in accordance with one or more embodiments described herein.

FIG. 1B shows a master node in accordance with one or more embodiments described herein.

FIG. 1C shows a worker node in accordance with one or more embodiments described herein.

FIG. 2 shows a flowchart describing a method for leader election container active support mode in accordance with one or more embodiments described herein.

FIG. 3 shows a flowchart describing a method for leader election container passive support mode in accordance with one or more embodiments described herein.

FIG. 4 shows a computing system in accordance with one or more embodiments described herein.

FIGS. 5A-5D show an example scenario in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to leader election for active-passive configured containerized application clusters. Particularly, in keeping a high availability environment encompassing a single pod instance of containerized applications, pod rescheduling (or redeployment) times, following single node failure, can sometimes take minutes rather than seconds. This is unacceptable as said pod rescheduling/redeployment times are too prolonged to maintain high availability.

Under said circumstances, the conventional wisdom is to deploy more than one pod replica (of the containerized applications) each executing on a separate node. Said recommendation can be achieved easily for stateless applications, however, when considering stateful services (e.g., legacy stateful applications, jobs to be performed on a repeating schedule, long running operations requiring monitoring, etc.) operating in active-passive high availability configurations, new challenges arise. By way of examples, said challenges, which need addressing, include determining: which pod replica is active versus which is/are passive? how should any incoming client traffic be routed only to the active pod replica to ensure full state consistency? how should a fast failover (lasting no more than seconds instead of minutes) be performed to a passive pod replica as a result of node failure of the node hosting the active pod replica? and how can split-brain scenarios, where multiple pod replicas assume the active replica pod role, be prevented?

Towards at least addressing these challenges, embodiments described herein propose a solution entailing the election of a leader (or active) pod replica amongst at least two pod replicas deployed across an active-passive configured containerized application cluster. The solution, more specifically, implements an elected leader lease (or locking mechanism) incapable of being held by more than one pod replica at any given point in time. The pod replica retaining the elected leader lease for any duration of time is designated the active pod replica, whereas any other pod replica(s) (not holding the elected leader lease) is/are each otherwise designated as a passive pod replica during said time duration. Further, upon attainment of the elected leader lease, the active pod replica patches the client traffic routing service of the containerized application cluster so that any incoming client traffic is directed solely to the active pod replica, or the node whereon the active pod replica executes. Moreover, in the case of node failure or lack of active pod replica readiness, a fast failover (or switching to a passive pod replica) may be delivered by configuring the active pod replica to forcibly surrender the held elected leader lease, thereby permitting any passive pod replica an opportunity to acquire the elected leader lease and assume the functionalities of the active replica pod without delay. Additionally, as a means for any pod replica to ascertain whether it is the active pod replica or not, the solution exposes an application programming interface (API) through which any pod replica may monitor the elected leader status.

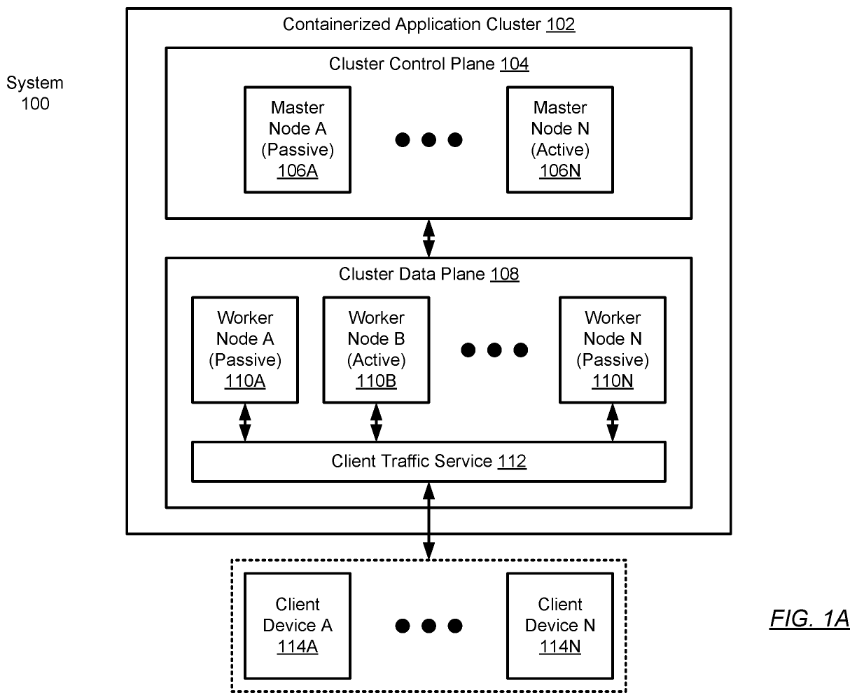

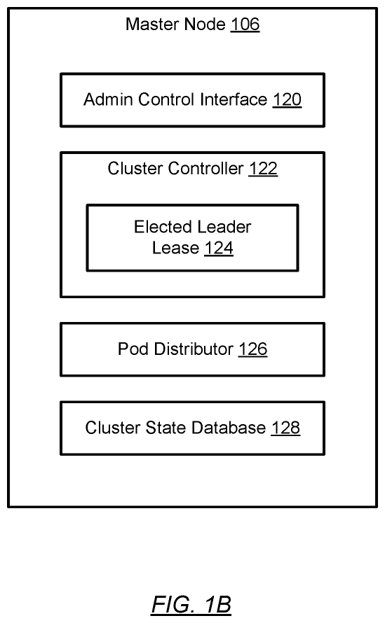

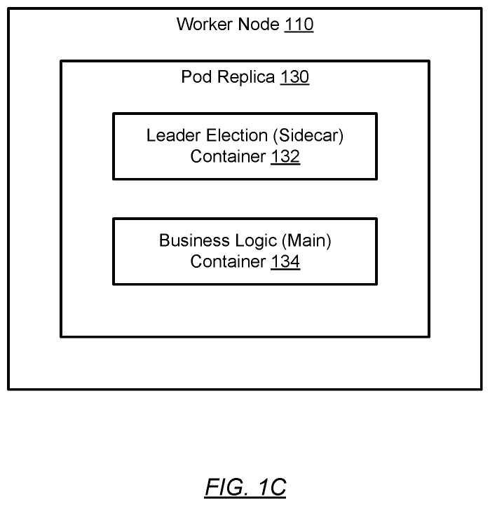

FIG. 1A shows a system in accordance with one or more embodiments described herein. The system (100) may include a containerized application cluster (102) and any number of client devices (114A-114N). Each of these system (100) components is described below.

In one or many embodiment(s) described herein, the containerized application cluster (102) may represent any information technology (IT) infrastructure at least configured for containerized application orchestration. Concerning said orchestration, the containerized application cluster (102) may include functionality to perform operational tasks necessary to deploy, run, and manage any number of containerized applications (also referred to herein as containers) (described below). One of ordinary skill, however, will appreciate that the containerized application cluster (102) may perform other functionalities without departing from the scope of the embodiments described herein.

In one or many embodiment(s) described herein, any containerized application (or container) may refer to a standalone, lightweight virtualization environment within which a software application and its dependencies (e.g., libraries, binaries, tools, configuration files/settings, etc.) execute. Any container, further, may be infrastructure- and/or operating system (OS)-agnostic, meaning that any container may operate on/over any hardware resources and/or OS. Said software application, in turn, may refer to a computer program, or computer readable instructions, which when executed or invoked, perform one or more tasks directed to a specific purpose.

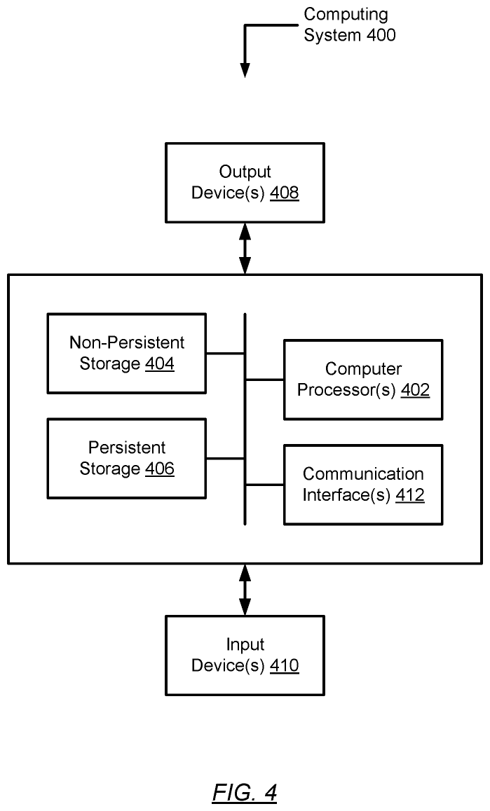

In one or many embodiment(s) described herein, the containerized application cluster (102) may be implemented through on-premises infrastructure, cloud computing infrastructure, or any hybrid infrastructure thereof. The containerized application cluster (102), accordingly, may be implemented using one or more network servers (not shown), where each said network server may represent a physical or a virtual network server. Additionally, or alternatively, the containerized application cluster (102) may be implemented using one or more computing systems similar to the exemplary computing system illustrated and described with respect to FIG. 4, below.

In one or many embodiment(s) described herein, the containerized application cluster (102) may include a cluster control plane (104). The cluster control plane (104) may represent a portion of the containerized application cluster (102) architecture dedicated to containerized application cluster (102) management. To said extent, the cluster control plane (104) may include functionality to: receive any number of work requests from any administrator(s) of the containerized application cluster (102), where said work request(s) each pertain to deploying any number of containers on the containerized application cluster (102) for any number of specific purposes; track cluster data plane (108) resources in order to determine whether or not to deploy any container(s) there-throughout to fulfill any work request(s); maintain any actual/current state pertinent to the containerized application cluster (102); and reconcile said actual/current containerized application cluster (102) state with a desired containerized application cluster (102) state. One of ordinary skill, however, will appreciate that the cluster control plane (104) may perform other functionalities without departing from the scope of the embodiments described herein.

In one or many embodiment(s) described herein, the cluster control plane (104) may include one or more master nodes (106A-106N), which substantively perform any functionalities of the cluster control plane (104). Any master node (106A-106N), therefore, may refer to a physical or a virtual appliance (e.g., a physical/virtual network server) at least configured to host any number of hardware and software resources (e.g., computer processors, memory, storage, virtualization, network bandwidth, etc.), as needed, to implement said cluster control plane (104) functionalities. Subcomponents of any master node (106A-106N) are illustrated and described in further detail with respect to FIG. 1B, below.

In one or many embodiment(s) described herein, at any given time during the operation of the containerized application cluster (102) and of the master node(s) (106A-106N) collectively forming the cluster control plane (104), a singular master node (e.g., 106N) may operate as an active master node, whereas the remaining master node(s) (if any) (e.g., 106A) each otherwise operate as a passive master node. That is, the master node(s) (106A-106N) may collectively operate in an active-passive high availability configuration, thereby providing the continuous availability of any cluster control plane (104) functionalities with minimal or zero downtime. Further, while operating in said active-passive high availability configuration, the master node(s) (106A-106N) may each contribute at least a portion of their respective storage resources (described below) to create a shared virtual storage pool (not shown) wherein and wherefrom any cluster configuration information (described below) and elected leader lease information (see e.g., FIG. 1B), pertinent to the containerized application cluster (102), may be stored and retrieved, respectively, by any active master node (e.g., 106N).

In one or many embodiment(s) described herein, storage resources of/on any master node (106A-106N) may include a collection of one or more physical storage devices (not shown) on which various forms of digital information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, cluster configuration information may refer to information detailing the operating state of the containerized application cluster (102) at any given point in time. By way of examples, said cluster configuration information may include: information identifying any worker node(s) (110A-110N), at least in part, forming the containerized application cluster (102); information identifying any number of containers deployed throughout the containerized application cluster (102), as well as of any software applications executing within each respectively; and information identifying which worker node(s) (110A-110N) may be hosting which deployed containers. Cluster configuration information, however, is not limited to the aforementioned specific examples.

In one or many embodiment(s) described herein, the containerized application cluster (102) may include a cluster data plane (108). The cluster data plane (108) may represent a portion of the containerized application cluster (102) architecture dedicated to software application execution. To that extent, the cluster data plane (108) may include functionality to: implement any work sought to be performed there-across via any number of deployed containers; support said deployed container(s) by providing resources (e.g., computer processors, memory, storage, network bandwidth, etc.) pertinent to their execution; and monitor and report any status(es) pertaining to said deployed container(s). One of ordinary skill, however, will appreciate that the cluster data plane (108) may perform other functionalities without departing from the scope of the embodiments described herein.

In one or many embodiment(s) described herein, the cluster data plane (108) may include two or more worker nodes (110A-110N), which substantively perform any functionalities of the cluster data plane (108). Any worker node (110A-110N), therefore, may refer to a physical or a virtual appliance (e.g., a physical/virtual network server) at least configured to host any number of hardware and software resources (e.g., computer processors, memory, storage, virtualization, network bandwidth, etc.), as needed, to implement said cluster data plane (108) functionalities. Subcomponents of any worker node (110A-110N) are illustrated and described in further detail with respect to FIG. 1C, below.

In one or many embodiment(s) described herein, at any given time during the operation of the containerized application cluster (102) and of the worker node(s) (110A-110N) collectively forming a portion of the cluster data plane (108), a singular worker node (e.g., 110B) may operate as an active worker node, whereas the remaining worker node(s) (e.g., 110A, 110N) each otherwise operate as a passive worker node. That is, the worker node(s) (110A-110N) may collectively operate in a high availability configuration (similar to the master node(s) (106A-106N)), thereby providing the continuous availability of any cluster data plane (108) functionalities with minimal or zero downtime.

In one or many embodiment(s) described herein, the cluster data plane (108) may further include a client traffic service (112). The client traffic service (112) may refer to a physical or a virtual appliance (e.g., a physical/virtual network server) at least configured for client traffic routing. Client traffic may refer to any incoming and/or outgoing network traffic involving any client device(s) (114A-114N). Incoming client traffic, for example, may encompass requests from any client device (114A-114N), while outgoing client traffic, for example, may include responses for said requests directed to the appropriate client device(s) (114A-114N).

In one or many embodiment(s) described herein, and at least in part, the client traffic service (112) may include functionality to: receive (incoming) client traffic from any client device (114A-114N); access information (e.g., one or more traffic routing and/or forwarding data structures) configured thereon identifying the current active worker node (e.g., 110B) of the containerized application cluster (104); transmit, at least based on the accessed information, the received (incoming) client traffic to the identified current active worker node; if applicable, receive (outgoing) client traffic from the identified current active worker node in reply to the transmitted (incoming) client traffic; and transmit the received (outgoing) client traffic to the appropriate client device (114A-114N). One of ordinary skill, however, will appreciate that the client traffic service (112) may perform other functionalities without departing from the scope of the embodiments described herein.

In one or many embodiment(s) described herein, any client device (114A-114N) may represent a physical or virtual appliance at least configured to receive, generate, process, store, and/or transmit data, as well as provide an environment in which one or many workload(s) may execute thereon. Any said workload (not shown) may refer, but is not limited, to a service offered locally or over a network (not shown), a computational task or function, a data transaction, or a software application. Further, in providing said execution environment for any workload(s) instantiated thereon, any client device (114A-114N) may include or have access to, and thus allocate and de-allocate, various resources (e.g., computer processors, memory, storage, virtualization, network bandwidth, etc.), as needed, to the workload(s). One of ordinary skill, however, will appreciate that any client device (114A-114N) may perform other functionalities without departing from the scope of the embodiments described herein.

For example, any client device (144A-114N) may include functionality to: submit, on behalf of any user thereof or any workload thereon, any number of requests (as client traffic) to the cluster data plane (108) (or more specifically, the client traffic service (112)), where said requests may each pertain to the specific purpose of a software application executing in a container deployed across the active-passive configuration of worker nodes (110A-110N); and receive, if applicable and in reply to any submitted requests, appropriate responses, relevant to the specific purpose of said software application, from the client traffic service (112).

Examples of any client device (114A-114N) may include, but are not limited to, a desktop computer, a laptop computer, a network server, a smartphone, a tablet computer, or any computing system similar to the exemplary computing system illustrated and described with respect to FIG. 4, below.

In one or many embodiment(s) described herein, the above-mentioned system (100) components (or subcomponents thereof) may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1A shows a configuration of components and/or subcomponents, other system (100) configurations may be used without departing from the scope of the embodiments described herein.

For example, in one or many embodiment(s) described herein, the system (100) may include one or more admin devices (not shown), which would operatively connect to any master node (106A-106N). Any admin device may represent a physical or virtual appliance wherefrom containerized application cluster (102) operations may be overseen by administrators thereof. To said extent, and at least in part, any admin device may include functionality to: apply any desired configuration (e.g., an active-passive configuration) and/or state, affecting any subset or all of the components and/or subcomponents of the containerized application cluster (102) via any master node (106A-106N); and issue workload requests for the creation, deployment, and execution of pod replicas (and/or containers) across the containerized application cluster (102). One of ordinary skill, however, will appreciate that any admin device may perform other functionalities without departing from the scope of the embodiments described herein. Examples of any admin device may include, but are not limited to, a desktop computer, a laptop computer, a tablet computer, a network server, a smartphone, or any other computing system similar to the exemplary computing system illustrated and described with respect to FIG. 4, below.

FIG. 1B shows a master node in accordance with one or more embodiments described herein. The master node (106) may include an admin control interface (120), a cluster controller (122), a pod distributor (126), and a cluster state database (128). Each of these master node (106) subcomponents is described below.

In one or many embodiment(s) described herein, the admin control interface (120) may refer to an enabler or a facilitator of communications (or information exchange) between the master node (106) and any admin device(s) (not shown) (described above). Examples of the admin control interface (120) may include networking hardware (e.g., a network card or adapter), a computer program implementing a logical interface (e.g., an application programming interface (API)) and executing on the underlying hardware of the master node (106), an interactivity protocol, or any combination thereof. Further, the admin control interface (120) is not limited to the aforementioned specific examples.

In one or many embodiment(s) described herein, and at least in part, the admin control interface (120) may include functionality to: receive incoming admin traffic (i.e., desired containerized application cluster configurations and/or state, issued workload requests, etc.) from any admin device(s); and provide said received incoming admin traffic to the cluster controller (122) and the cluster state database (128) for servicing and storing, respectively. One of ordinary skill, however, will appreciate that the admin control interface (120) may perform other functionalities without departing from the scope of the embodiments described herein.

In one or many embodiment(s) described herein, the cluster controller (122) may refer to instruction-processing hardware (e.g., any number of integrated circuits for processing computer readable instructions), a computer program executing on the underlying hardware of the master node (106), or any combination thereof, at least configured to regulate a current state of the containerized application cluster (against a desired state thereof).

In one or many embodiment(s) described herein, the cluster controller (122) may implement, and thus maintain, an elected leader lease (124). The elected leader lease (124) may refer to a virtual locking mechanism configured to prevent more than one pod replica (and by extension, prevent more than one hosting worker node thereof) from functioning as the active pod replica (and active worker node), respectively, amongst the active-passive configuration of pod replicas (and worker nodes) across the containerized application cluster. Accordingly, the elected leader lease (124) may be acquired or held by a singular pod replica at any given point in time, where said singular pod replica may be designated and thus act as the active pod replica. Conversely, any one or more pod replicas (and by association, any one or more hosting worker nodes thereof), which does not currently hold the elected leader lease (124), may each otherwise be designated and thus function as a passive pod replica (and passive working node), respectively.

In one or many embodiment(s) described herein, the elected leader lease (124) may include, exhibit, or otherwise be associated with elected leader lease information, which portrays a current state of the elected leader lease (124). Examples of said elected leader lease information may include: an identifier uniquely pertaining to a current lease tenant or holder (e.g., a pod replica) of the elected leader lease (124); a lease duration specifying a maximum span of time onto which the elected leader lease (124) may be held; and an observed timestamp encoding time from a real-time clock used in determining whether it is time to renew (or reacquire) the elected leader lease (124) by the current active pod replica, or time to pursue the attempted acquisition of the elected leader lease (124) by any current passive pod replica(s). The elected leader lease information, however, is not limited to the aforementioned specific examples.

In one or many embodiment(s) described herein, the pod distributor (126) may refer to instruction-processing hardware (e.g., any number of integrated circuits for processing computer readable instructions), a computer program executing on the underlying hardware of the master node (106), or any combination thereof, at least configured to schedule (or otherwise deploy) any number of pod replicas across the worker nodes, of the containerized application cluster, for execution.

In one or many embodiment(s) described herein, the cluster state database (128) may refer to a dedicated data repository at least configured to persistently maintain any desired configuration and/or any desired state pertinent to the containerized application cluster.

While FIG. 1B shows a configuration of components and/or subcomponents, other master node (106) configurations may be used without departing from the scope of the embodiments described herein.

FIG. 1C shows a worker node in accordance with one or more embodiments described herein. The worker node (110) may include a pod replica (130), which is described below.

In one or many embodiment(s) described herein, the pod replica (130) may refer to a logical construct at least configured to encapsulate one or more containers therein for execution. In supporting any container(s) therein, the pod replica (130) may provide any environmental dependencies, including access to persistent storage, as well as configuration settings and/or state needed for container operation.

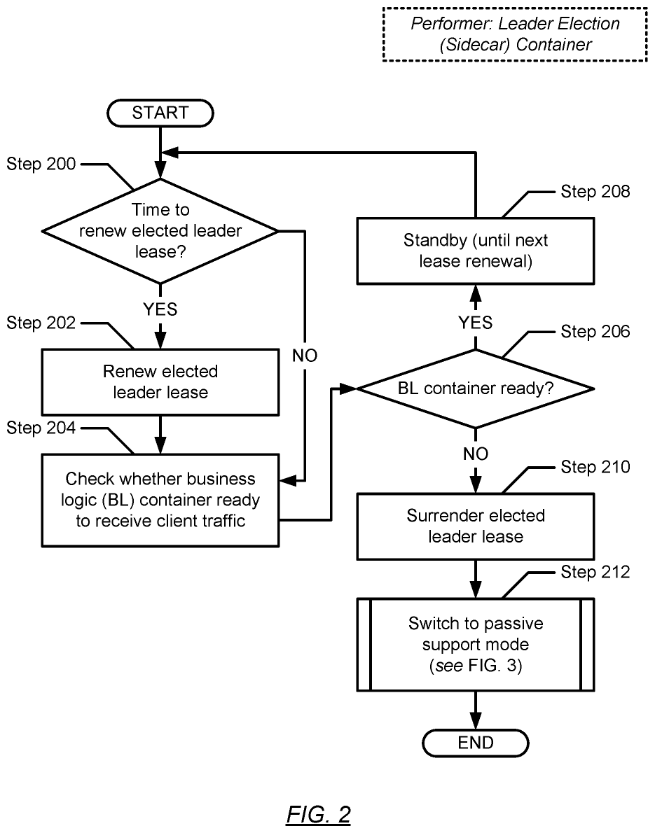

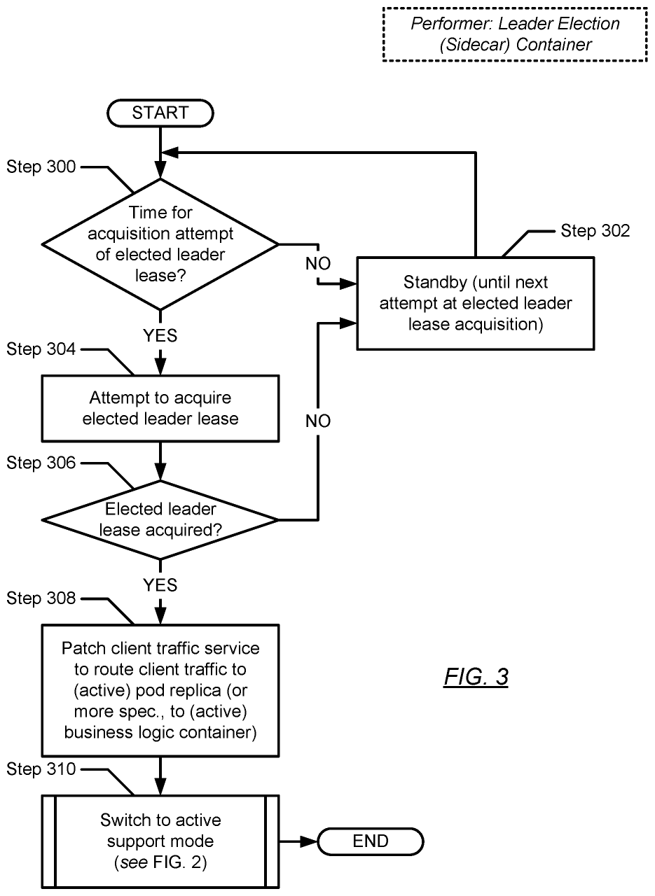

In one or many embodiment(s) described herein, the pod replica (130) may include or host a leader election container (132). The leader election container (132) may refer to a sidecar (or auxiliary) container that executes alongside the main container—i.e., the business logic container (134)—within the pod replica (130). Any sidecar container generally enhances or extends the functionality of the main container through the implementation of supplemental services or features. Particularly, the leader election container (132) supports the business logic container (134) by including functionality to perform the methods, concerning leader (or active) pod replica election, illustrated and described with respect to FIGS. 2 and 3, below. One of ordinary skill, however, will appreciate that the leader election container (132) may perform other functionalities without departing from the scope of the embodiments described herein.

In one or many embodiment(s) described herein, the pod replica (130) may further include or host a business logic container (134). The business logic container (134) may refer to a main container that executes within the pod replica (130). Unlike a sidecar container—i.e., the leader election container (132)—which provides supporting functionality thereto, the main container implements the primary operations for which the pod replica (130) had been deployed. By way of examples, said primary operations may include: the processing of one or more modalities (e.g., text, tabular, audio, images, video, etc.) of data; database maintenance; financial transactions accounting; and metrics capturing and analytics. Further, said primary operations are not limited to the aforementioned specific examples.

While FIG. 1C shows a configuration of components and/or subcomponents, other worker node (110) configurations may be used without departing from the scope of the embodiments described herein.

FIG. 2 shows a flowchart describing a method for leader election container active support mode in accordance with one or more embodiments described herein. The various steps outlined below may be performed by a leader election container (see e.g., FIG. 1C) executing in an actively running (or active) pod replica. Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, a determination is made as to whether it is time to renew the elected leader lease (see e.g., FIG. 1B). The determination may entail assessing at least a portion of any elected leader lease information reflecting a current state of the elected leader lease. In one or many embodiment(s) described herein, if it is determined, based on the assessment of the elected leader lease information, that it is indeed time to renew the elected leader lease, then the method proceeds to Step 202. On the other hand, in one or many other embodiment(s) described herein, if it is alternatively determined, based on the assessment of the elected leader lease information, that it is not yet time to renew the elected leader lease, then the method alternatively proceeds to Step 204.

In Step 202, following the determination (made in Step 200) that it is indeed time for elected leader lease renewal, the elected leader lease is reacquired and thus renewed. In one or many embodiment(s) described herein, renewal of the elected leader lease may result in the confirmation of certain elected leader lease information (e.g., an identifier uniquely pertaining to the current active replica pod) maintained on the active master node of the containerized application cluster.

In Step 204, following the alternate determination (made in Step 200) that it is not yet time for elected leader lease renewal, or following renewal of the elected leader lease (performed in Step 202), a readiness state of the business logic (BL) container (see e.g., FIG. 1C) is assessed. In one or many embodiment(s) described herein, the readiness state may reflect whether the BL container is ready or not ready to receive and service any incoming client traffic. Examples for which the BL container may not be ready may include, but are not limited to, the need to load certain state, the accessing of large configuration files, and the accessing of other service(s) necessary to be ready. Further, assessment of the readiness state may, for example, entail a check using a readiness probe, such as: a hypertext transfer protocol (HTTP) probe configured to send a HTTP request to a specific endpoint in the BL container and check if a successful response is received; a transmission control protocol (TCP) probe configured to check if a specific port is open and listening on the BL container; and/or a command probe configured to execute a custom command within the BL container and check if the command returns an appropriate response.

In Step 206, based on the readiness state of the BL container (assessed in Step 204), a determination is made as to whether the BL container is ready to receive and service any incoming client traffic. In one or many embodiment(s) described herein, if it is determined that the BL container is ready, then the method proceeds to Step 208. On the other hand, if it is alternatively determined that the BL container is not ready, then the method alternatively proceeds to Step 210.

In Step 208, following the determination (made in Step 208) that the BL container is ready to receive and service any incoming client traffic, the leader election container (performing the method) remains on standby. While on standby, in one or many embodiment(s) described herein, the leader election container may continue to monitor certain elected leader lease information (e.g., observed timestamp) to discern when to proceed in elected leader lease renewal again (see e.g., Step 200).

In Step 210, following the alternate determination (made in Step 208) that the BL container is not ready to receive and service any incoming client traffic, the elected leader lease (held by the replica pod associated with the leader election container performing the method) is surrendered. In one or many embodiment(s) described herein, surrendering of the elected leader lease results in a fast failover (lasting mere seconds), thereby permitting the attempted acquisition of the elected leader lease, and thus the assumption of any active pod replica functionalities, by a passive pod replica. Further, surrendering of the elected leader lease may entail vacancy or removal of certain elected leader lease information (e.g., an identifier uniquely pertaining to the current active pod replica) maintained on the active master node of the containerized application cluster.

In Step 212, the operational mode, of the leader election container (performing the method), is switched to that of a passive support mode (see e.g., FIG. 3). In one or many embodiment(s) described herein, the passive support mode may govern a programmed behavior of the leader election container to support the BL container while the pod replica (associated therewith) is no longer actively running and is thus re-designated as a passive pod replica.

FIG. 3 shows a flowchart describing a method for leader election container passive support mode in accordance with one or more embodiments described herein. The various steps outlined below may be performed by a leader election container (see e.g., FIG. 1C) executing in an inactively running (or passive) pod replica. Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a determination is made as to whether it is time to attempt acquisition of the elected leader lease. The determination may entail assessing at least a portion of any elected leader lease information reflecting a current state of the elected leader lease. In one or many embodiment(s) described herein, if it is determined, based on the assessment of the elected leader lease information, that it is not yet time to attempt acquisition of the elected leader lease, then the method proceeds to Step 302. On the other hand, in one or many other embodiment(s) described herein, if it is alternatively determined, based on the assessment of the elected leader lease information, that it is indeed time to attempt acquisition of the elected leader lease, then the method alternatively proceeds to Step 304.

In Step 302, following the determination (made in Step 300) that it is not yet time to attempt acquisition of the elected leader lease, or following the determination (to be made in Step 306) (described below) that the attempted acquisition of the elected leader lease failed based on the attempted acquisition thereof (to be performed in Step 304) (described below), the leader election container (performing the method) remains on standby. While on standby, in one or many embodiment(s) described herein, the leader election container may continue to monitor certain elected leader lease information (e.g., observed timestamp) to discern when to proceed in attempt acquisition of the elected leader lease again (see e.g., Step 300).

In Step 304, following the alternate determination (made in Step 300) that it is time to attempt acquisition of the elected leader lease, acquisition of the elected leader lease is attempted. In one or many embodiment(s) described herein, said attempt may entail: assessing whether certain elected leader lease information (e.g., an identifier uniquely pertaining to the current active pod replica) is vacant; and if so, being the first to occupy said certain elected leader lease information through a configuration thereof (e.g., changing the vacancy to reflect an identifier uniquely pertaining to the pod replica associated with or within which the leader election container (performing the method) is executing).

In Step 306, based on the attempted acquisition of the elected leader lease (performed in Step 304), a determination is made as to whether said acquisition attempt succeeded. The determination may entail, for example, feedback from the active master node that certain (previously vacant) elected leader lease information has been successfully updated to reflect the identifier uniquely pertaining to the pod replica associated with the leader election container (performing the method). Conversely, said feedback may instead inform that said certain (previously vacant) elected leader lease information has failed to update because, for example, another passive pod replica was the first to successfully acquire, or the current active pod replica has successfully renewed, the elected leader lease. As such, in one or many embodiment(s) described herein, if it is determined that the attempted acquisition of the elected leader lease has failed, then the method proceeds to Step 302 (described above). On the other hand, in one or many other embodiment(s) described herein, if it is alternatively determined that the attempted acquisition of the elected leader lease has succeeded, then the method alternatively proceeds to Step 308.

In Step 308, following the alternate determination (made in Step 306) that the attempted acquisition of the elected leader lease succeeded, the client traffic service (see e.g., FIG. 1A) is patched. Particularly, in one or many embodiment(s) described herein, routing/forwarding information, maintained by or configured on the client traffic service, may be updated to reflect the pod replica (associated with the leader election container (performing the method)) as the active pod replica. Said update of the routing/forwarding information may substantively reprogram the client traffic service to direct any new incoming client traffic solely to the active pod replica (or more specifically, to the business logic container operating therein).

As a note, should the client traffic service behave conventionally (i.e., irrespective of embodiments described herein), the directing of any incoming client traffic thereby follows a round robin algorithm. In implementing said round robin algorithm, a topology awareness is necessary amongst any client device(s) and/or any business logic container(s), which embodiments described herein desire to avoid.

In Step 310, the operational mode, of the leader election container (performing the method), is switched to that of an active support mode (see e.g., FIG. 2). In one or many embodiment(s) described herein, the active support mode may govern a programmed behavior of the leader election container to support the BL container while the pod replica (associated therewith) is actively running and is thus re-designated as the active pod replica.

FIG. 4 shows a computing system in accordance with one or more embodiments described herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one or many embodiment(s) described herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one or many embodiment(s) described herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

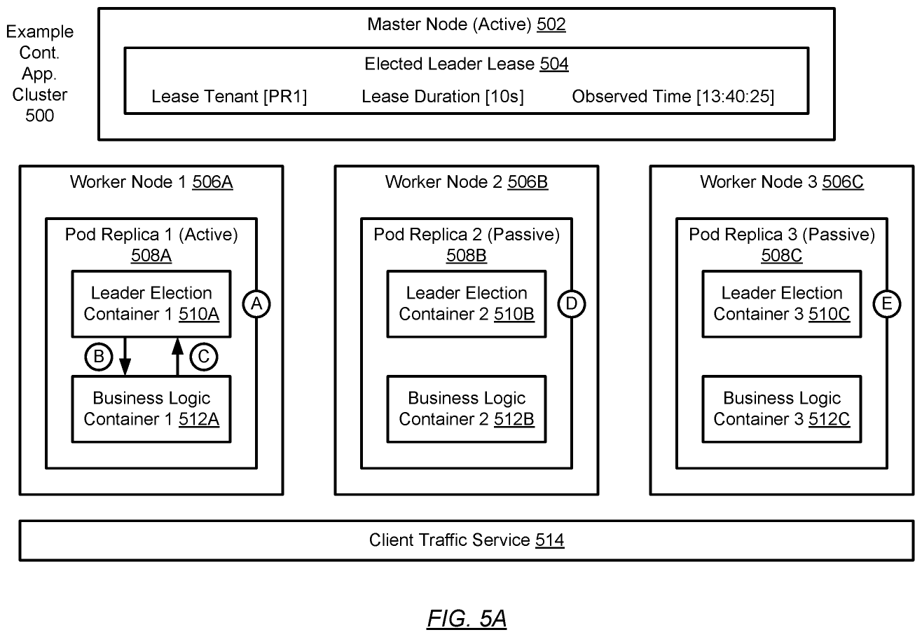

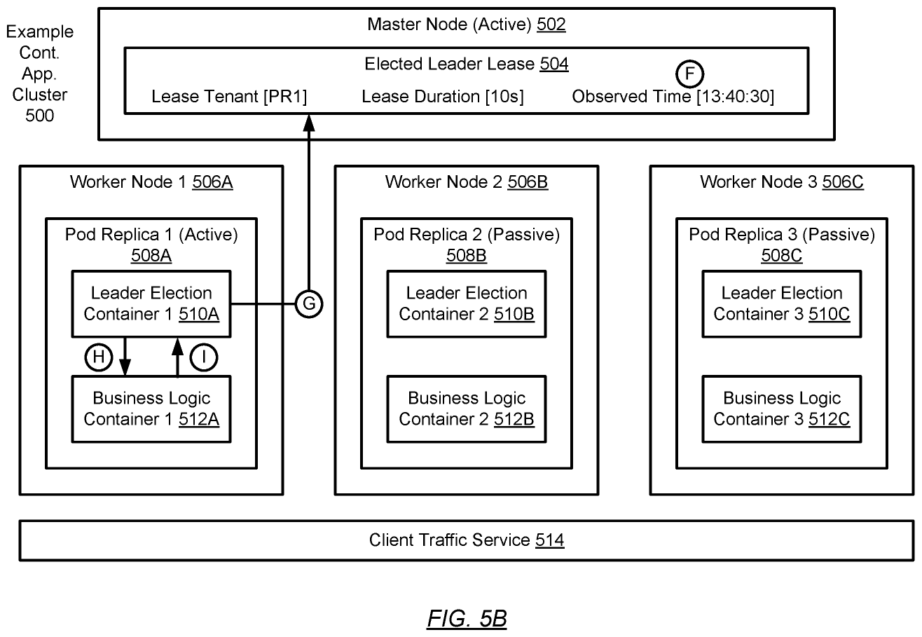

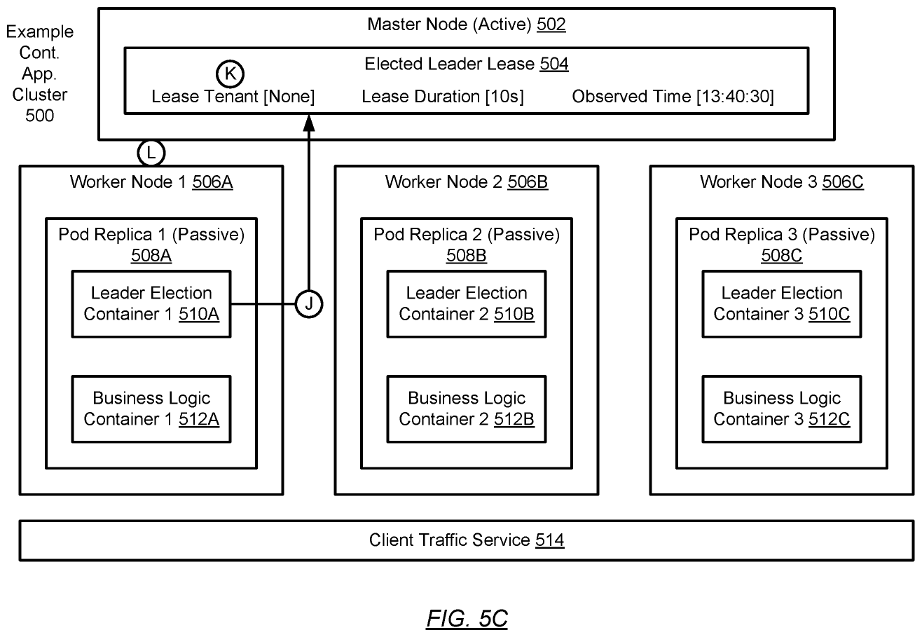

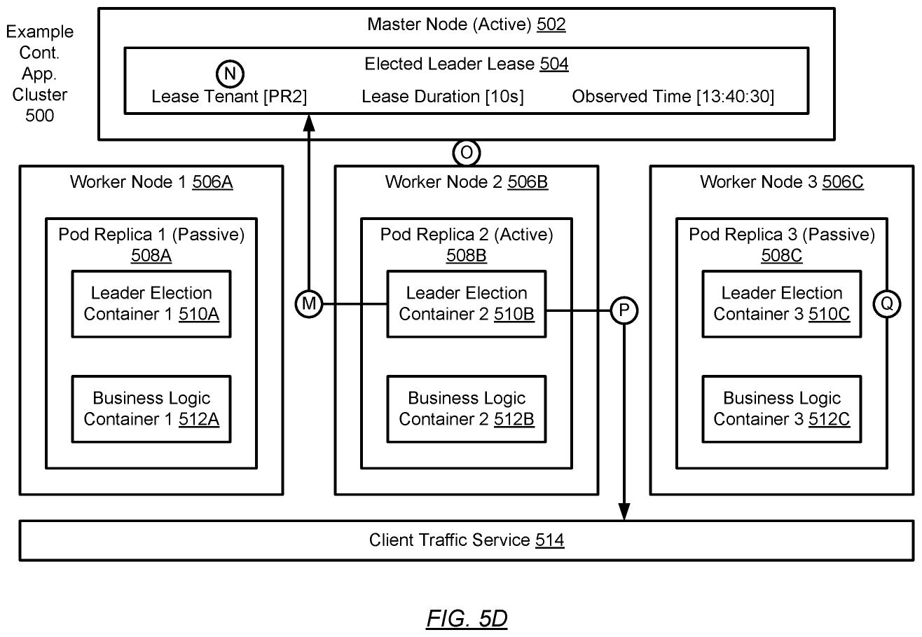

FIGS. 5A-5D show an example scenario in accordance with one or more embodiments described herein. The following example scenario is for explanatory purposes only and not intended to limit the scope of the embodiments described herein.

Throughout FIGS. 5A-5D, an example containerized application cluster (500) is portrayed. The example containerized application cluster (500) includes a single (active) master node (502) representing a cluster control plane (not shown) thereof, as well as a trio of worker nodes (506A-506C) and a client traffic service (514) collectively representing a cluster data plane (not shown) thereof.

The single (active) master node (502) implements and maintains an elected leader lease (504), which is associated with, includes, or exhibits elected leader lease information. Said elected leader lease information includes: (a) a lease tenant field, which, when the elected leader lease (504) is acquired/held by a given pod replica, reflects an identifier uniquely pertaining to the given pod replica; (b) a lease duration field which indicates a maximum span of time during which the elected leader lease (504) can be acquired/held by a given pod replica—the elapsing of which triggers either the renewed acquisition of the elected leader lease (504) by a current active pod replica, or the attempted acquisition of the elected leader lease (504) by a current passive pod replica; and (c) an observed time field which reflects a timestamp, encoding relative time, against which determinations may be made as to whether it is time to renewal (or attempt acquisition) of the elected leader lease (504) by the appropriate pod replica.

Each worker node (506A-506C) hosts a pod replica (508A-508C), which, in turn, supports a leader election container (510A-510C) and a business logic container (512A-512C). As the pod replicas (508A-508C) collectively operate in an active-passive high availability configuration, each pod replica (508A-508C) (and by extension, each leader election container (510A-510C) and each business logic container (512A-512C) executing respectively there-within) is an identical instance of one another (i.e., entailing the same configuration, software application, etc.). What is not identical, however, is that only a single pod replica (e.g., 508A) is initially actively running and is thus designated the active pod replica, whereas the remaining two pod replicas (e.g., 508B, 508C) are each initially on standby and is thus designated as a passive pod replica.

The client traffic service (514) awaits to receive any incoming client traffic from any client device (not shown). Upon receiving any incoming client traffic, the client traffic service (514) directs said incoming client traffic to the appropriate (active) pod replica for servicing.

Concerning the example scenario, consider the following actions, performed by the leader election containers (510A-510C) in accordance with embodiments described herein.

Turning to FIG. 5A:
A. Leader Election Container 1 (510A) assesses certain elected leader lease information (e.g., observed time field) and determines it is not yet time to seek renewal of the elected leader lease (504);
B. Leader Election Container 1 (510A) subsequently probes a readiness state of Business Logic Container 1 (512A) to ascertain whether Business Logic Container 1 (512A) is ready to receive and service any new, incoming client traffic;
C. Leader Election Container 1 (510A) learns that Business Logic Container 1 (512A) is ready;
D. Leader Election Container 2 (510B) assesses certain elected leader lease information (e.g., observed time field) and determines it is not yet time to seek an attempted acquisition of the elected leader lease (504);
E. Leader Election Container 3 (510C) assesses certain elected leader lease information (e.g., observed time field) and determines it is not yet time to seek an attempted acquisition of the elected leader lease (504);

Turning to FIG. 5B:
F. The observed time field, of the elected leader lease information, updates to reflect the propagation of time (i.e., from 13:40:25 to 13:40:30);
G. Leader Election Container 1 (510A) assesses certain elected leader lease information (e.g., observed time field) and determines it is now time to seek renewal of the elected leader lease (504), where said renewal is implemented by reaffirming that other certain elected leader lease information (e.g., lease tenant field) continues to reflect the identifier (i.e., PR1) uniquely pertaining to Pod Replica 1 (508A);
H. Leader Election Container 1 (510A) subsequently probes a readiness state of Business Logic Container 1 (512A) to ascertain whether Business Logic Container 1 (512A) is ready to receive and service any new, incoming client traffic;
I. Leader Election Container 1 (510A) learns that Business Logic Container 1 (512A) is not ready this time around;

Turning to FIG. 5C:
J. Because Business Logic Container 1 (512A) is not ready, Leader Election Container 1 (510A) surrenders the elected leader lease (504);
K. Surrendering of the elected leader lease (504) results in the vacancy of certain elected leader lease information (e.g., lease tenant field);
L. Vacancy of said certain elected leader lease information (e.g., lease tenant field) triggers the re-designation of Pod Replica 1 (508A) as a passive replica pod;

Turning to FIG. 5D:
M. Leader Election Container 2 (510B) assesses certain elected leader lease information (e.g., observed time field) and determines it is now time to seek an attempted acquisition of the elected leader lease (504), where said attempt results in the successful acquisition thereof;
N. Having succeeded in acquiring the elected leader lease (504), Leader Election Container 2 (510B) updates other certain elected leader lease information (e.g., lease tenant field) to reflect the identifier (i.e., PR2) uniquely pertaining to Pod Replica 2 (508B);
O. Update of said other certain elected leader lease information (e.g., lease tenant field) triggers the re-designation of Pod Replica 2 (508B) as the active replica pod;
P. Leader Election Container 2 (510B) patches Client Traffic Service (514), where said patching reconfigures Client Traffic Service (514) to route any new, incoming client traffic to Pod Replica 2 (508B) (or more specifically, Business Logic Container 2 (512B)) for servicing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for designating an active pod replica amongst a plurality of pod replicas operating in an active-passive configuration within a containerized application cluster, the method comprising:
implementing, by a master node of the containerized application cluster, an elected leader lease;
making an attempt, by a leader election container executing in a pod replica of the plurality of pod replicas, to acquire the elected leader lease;
making a determination, based on the attempt and by the leader election container, that the elected leader lease has been successfully acquired; and
designating, based on the determination and by the leader election container, the pod replica as the active pod replica.

2. The method of claim 1, wherein a business logic container further executes in the pod replica.

3. The method of claim 2, wherein designating the pod replica as the active pod replica, comprises:
exposing, by the leader election container and to the business logic container, an application programming interface (API) configured to communicate an elected leader status.

4. The method of claim 2, the method further comprising:
assessing, by the leader election container, a readiness state for the business logic container;
making a second determination, based on the readiness state and by the leader election container, that the business logic container is not ready to receive client traffic for servicing; and
surrendering, based on the second determination and by the leader election container, the leader election lease.

5. The method of claim 1, wherein the leader election container is a sidecar container.

6. The method of claim 1, the method further comprising:
patching, by the leader election container and of the containerized application cluster, a client traffic service to route client traffic solely to the active pod replica for servicing.

7. The method of claim 1, wherein each pod replica of the plurality of pod replicas is hosted on a separate worker node of multiple worker nodes of the containerized application cluster.

8. A non-transitory computer readable medium (CRM) comprising computer readable program code, which when executed by computer processors, enables the computer processors to perform a method for designating an active pod replica amongst a plurality of pod replicas operating in an active-passive configuration within a containerized application cluster, the method comprising:
implementing, by a master node of the containerized application cluster, an elected leader lease;
making an attempt, by a leader election container executing in a pod replica of the plurality of pod replicas, to acquire the elected leader lease;
making a determination, based on the attempt and by the leader election container, that the elected leader lease has been successfully acquired; and
designating, based on the determination and by the leader election container, the pod replica as the active pod replica.

9. The non-transitory CRM of claim 8, wherein a business logic container further executes in the pod replica.

10. The non-transitory CRM of claim 9, wherein designating the pod replica as the active pod replica, comprises:
exposing, by the leader election container and to the business logic container, an application programming interface (API) configured to communicate an elected leader status.

11. The non-transitory CRM of claim 9, the method further comprising:
assessing, by the leader election container, a readiness state for the business logic container;
making a second determination, based on the readiness state and by the leader election container, that the business logic container is not ready to receive client traffic for servicing; and
surrendering, based on the second determination and by the leader election container, the leader election lease.

12. The non-transitory CRM of claim 8, wherein the leader election container is a sidecar container.

13. The non-transitory CRM of claim 8, the method further comprising:
patching, by the leader election container and of the containerized application cluster, a client traffic service to route client traffic solely to the active pod replica for servicing.

14. The non-transitory CRM of claim 8, wherein each pod replica of the plurality of pod replicas is hosted on a separate worker node of multiple worker nodes of the containerized application cluster.

15. A containerized application cluster, comprising:
a plurality of worker nodes, comprising:
a worker node, comprising:
a computer processor;
a pod replica executing on the computer processor; and
a leader election container executing on the computer processor and within the pod replica, and configured to perform a method for designating an active pod replica within the containerized application cluster, the method comprising:
making an attempt to acquire an elected leader lease;
making a determination, based on the attempt, that the elected leader lease has been successfully acquired; and
designating, based on the determination, the pod replica as the active pod replica.

16. The containerized application cluster of claim 15, further comprising:
a master node operatively connected to the plurality of worker nodes, and comprising:
a second computer processor configured to implement and maintain the elected leader lease.

17. The containerized application cluster of claim 15, further comprising:
a client traffic service operatively connected to the plurality of worker nodes, and comprising:
a second computer processor configured to route incoming client traffic,
wherein the method further comprises:
patching the client traffic service to route the incoming client traffic solely to the active pod replica.

18. The containerized application cluster of claim 17, the worker node further comprising:
a business logic container executing on the computer processor and within the pod replica, and configured to service the incoming client traffic.

19. The containerized application cluster of claim 15, wherein the leader election container is a sidecar container.

20. The containerized application cluster of claim 15, wherein the pod replica is one of a plurality of pod replicas collectively operating in an active-passive configuration throughout the containerized application cluster.
